(19) United States
(12) Patent Application Publication
(10) Pub. No.: US 2021/0201273 A1
(43) Pub. Date: Jul. 1, 2021

(54) DUCTWORK AND FIRE SUPPRESSION SYSTEM VISUALIZATION

(71) Applicant: CARRIER CORPORATION, Palm Beach Gardens, FL (US)

(72) Inventors: Prasad Babu Lakshmipathy, Hyderabad, Telangana (IN); Sowmya Paturu, Hyderabad, Telangana (IN); Sreeramya Soratkal, Hyderabad, Telangana (IN); Saurabh Kumar Sinha, Hyderabad, Telangana (IN); Balaji Kaliappan, Hyderabad, Telangana (IN)

(21) Appl. No.: 17/057,154

(22) PCT Filed: Jul. 23, 2019
(86) PCT No.: PCT/US19/42992

§ 371 Date: Nov. 20, 2020

(30) Foreign Application Priority Data
Aug. 14, 2018 (IN) 201811030566

(51) Int. Cl. G06Q 10/00; G06F 30/12; G06F 30/13; G06F 30/17; G06F 30/18; G06T 19/00; G06K 9/00

(52) U.S. Cl. CPC G06Q 10/20; G06F 30/12; G06F 30/13; G06F 2111/18; G06F 30/18; G06T 19/006; G06K 9/00771; G06F 30/17

(57) ABSTRACT

A system is provided that includes a memory system storing a plurality of executable instructions. The system also includes a processing system operably coupled to the memory system. The executable instructions when executed by the processing system cause the system to access a plurality of building structural data, ductwork layout data, and fire suppression system layout data associated with a building. A location of a user device within the building is identified. An overlay image is created that includes a three-dimensional depiction of a portion of a ductwork layout and a fire suppression system layout based on an overlay of the ductwork layout data and the fire suppression system layout data with respect to the building structural data and the location of the user device. The overlay image is output to a display component.

### BACKGROUND

The subject matter disclosed herein generally relates to the field of building systems, and more particularly to a system to provide a visualization of ductwork and a fire suppression system within a building.

Design, installation, assessment, and commissioning of heating, ventilation, and air conditioning (HVAC) systems and fire suppression systems in a building is often based solely on expert knowledge. Similarly, retrofit designs of HVAC systems and/or fire suppression systems in existing buildings typically rely upon expert knowledge of available options that are compatible with building infrastructure. Different design teams may separately design ductwork and fire suppression systems for one or more floors of a building; however, it is possible that the resulting layouts may conflict with each other, leading to rerouting upon installation. Further, once ductwork and fire suppression systems are concealed within walls or ceilings of a building, it can be challenging to locate components in need of servicing.

### BRIEF DESCRIPTION

In accordance with one or more embodiments, a system is provided that includes a memory system storing a plurality of executable instructions. The system also includes a processing system operably coupled to the memory system. The executable instructions when executed by the processing system cause the system to access a plurality of building structural data, ductwork layout data, and fire suppression system layout data associated with a building. A location of a user device within the building is identified. An overlay image is created that includes a three-dimensional depiction of a portion of a ductwork layout and a fire suppression system layout based on an overlay of the ductwork layout data and the fire suppression system layout data with respect to the building structural data and the location of the user device. The overlay image is output to a display component.

In addition to one or more of the features described above or below, or as an alternative, further embodiments may include where the display component includes a display screen.

In addition to one or more of the features described above or below, or as an alternative, further embodiments may include where the executable instructions when executed by the processing system cause the system to access a plurality of image data received from a camera at the location, generate an augmented reality view based on a combination of the image data and the overlay image, and output the augmented reality view to the display screen.

In addition to one or more of the features described above or below, or as an alternative, further embodiments may include where the display component includes a holographic projector, and the overlay image is output as a holographic projection by the holographic projector.

In addition to one or more of the features described above or below, or as an alternative, further embodiments may include where the executable instructions when executed by the processing system cause the system to identify a routing conflict between the ductwork layout and the fire suppression system layout, and output a notification of the routing conflict.

In addition to one or more of the features described above or below, or as an alternative, further embodiments may include where the executable instructions when executed by the processing system cause the system to receive a diagnostic notification from a building monitoring system, map the diagnostic notification to a service location in the building, and output an indicator with the overlay image to highlight the diagnostic notification at the service location.

In addition to one or more of the features described above or below, or as an alternative, further embodiments may include where the executable instructions when executed by the processing system cause the system to scale the ductwork layout and the fire suppression system layout in the overlay image to match a plurality of actual dimensions of the ductwork layout and the fire suppression system layout.

In addition to one or more of the features described above or below, or as an alternative, further embodiments may include where the overlay image is scaled to project onto an installation surface of the ductwork layout and the fire suppression system layout.

In addition to one or more of the features described above or below, or as an alternative, further embodiments may include where the overlay image is scaled to project onto a surface covering the ductwork layout and the fire suppression system layout.

In addition to one or more of the features described above or below, or as an alternative, further embodiments may include where the executable instructions when executed by the processing system cause the system to adjust the overlay image as the user device is moved to a different location and/or orientation.

In accordance with one or more embodiments, a method includes accessing a plurality of building structural data, ductwork layout data, and fire suppression system layout data associated with a building, and identifying a location of a user device within the building. An overlay image is created that includes a three-dimensional depiction of a portion of a ductwork layout and a fire suppression system layout based on an overlay of the ductwork layout data and the fire suppression system layout data with respect to the building structural data and the location of the user device. The overlay image is output to a display component.

In addition to one or more of the features described above or below, or as an alternative, further embodiments may include accessing a plurality of image data received from a camera at the location, generating an augmented reality view based on a combination of the image data and the overlay image, and outputting the augmented reality view to the display screen.

In addition to one or more of the features described above or below, or as an alternative, further embodiments may include identifying a routing conflict between the ductwork layout and the fire suppression system layout, and outputting a notification of the routing conflict.

In addition to one or more of the features described above or below, or as an alternative, further embodiments may include receiving a diagnostic notification from a building monitoring system, mapping the diagnostic notification to a service location in the building, and outputting an indicator with the overlay image to highlight the diagnostic notification at the service location.

In addition to one or more of the features described above or below, or as an alternative, further embodiments may include scaling the ductwork layout and the fire suppression system layout in the overlay image to match a plurality of actual dimensions of the ductwork layout and the fire suppression system layout.

In addition to one or more of the features described above or below, or as an alternative, further embodiments may include adjusting the overlay image as the user device is moved to a different location and/or orientation.

Technical effects of embodiments of the present disclosure include creation and display of ductwork layout and fire suppression system layout within a building to assist detecting potential installation conflicts and to assist in locating concealed components in need of servicing after installation.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The following descriptions should not be considered limiting in any way. With reference to the accompanying drawings, like elements are numbered alike:

FIG. 1 depicts a design and visualization system in accordance with one or more embodiments;

FIG. 2 depicts a system at a building in accordance with one or more embodiments;

FIG. 3 depicts a user device in accordance with one or more embodiments;

FIG. 4 depicts an augmented reality display in accordance with one or more embodiments; and

FIG. 5 depicts a process flow in accordance with one or more embodiments.

### DETAILED DESCRIPTION

A detailed description of one or more embodiments of the disclosed apparatus and method are presented herein by way of exemplification and not limitation with reference to the Figures.

Embodiments disclosed herein may include a system, method, and/or computer program product for a creating an overlay image of a three-dimensional depiction of design details within a structure, such as a building. The three-dimensional depiction can be projected as a holographic image within the structure or can be displayed on a display device, such as a display screen of a user device. Embodiments can assist designers during a commissioning process of ductwork for a heating, ventilation, and air conditioning (HVAC) system and piping of a fire suppression system that may overlap or otherwise interfere with each other when installed in a building.

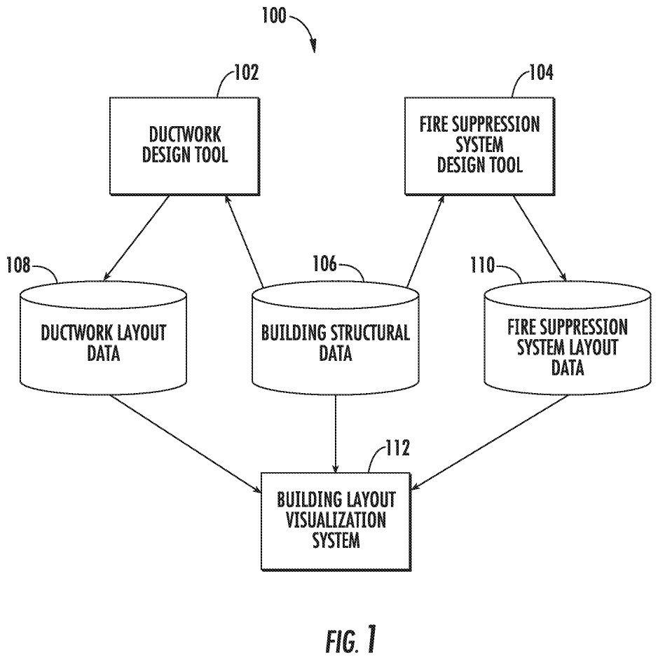

Turning now to FIG. 1, a system 100 is depicted in accordance with one or more embodiments. The system 100 can include a ductwork design tool 102 and a fire suppression system design tool 104. The ductwork design tool 102 can access building structural data 106 to determine physical dimensions, support structure locations, and other building-specific constraints for routing ductwork to support an HVAC system within a building. The ductwork design tool 102 can output ductwork layout data 108 as an information model with a computer-aided design (CAD) layout defining sizes and locations of components of ductwork to be installed in a building relative to the location data from the building structural data 106. The fire suppression system design tool 104 can also access building structural data 106 to determine physical dimensions, support structure locations, and other building-specific constraints for routing conduit to support a fire suppression system within a building. The fire suppression system design tool 104 can output fire suppression system layout data 110 as an information model with a CAD layout defining sizes and locations of components of fire suppression system components, such as pipes and sprinkler locations, to be installed in a building relative to the location data from the building structural data 106. The ductwork design tool 102 and the fire suppression system design tool 104 may be executed on different computer systems or as cloud-based applications for different groups of users.

The system 100 also include a building layout visualization system 112 that can access (e.g., retrieve or receive) the building structural data 106, the ductwork layout data 108, the fire suppression system layout data 110, and/or other data to support creation and display of a three-dimensional depiction the ductwork and fire suppression system defined respectively in the ductwork layout data 108 and the fire suppression system layout data 110. The building layout visualization system 112 can be implemented on any type of computer system and/or distributed between multiple computer systems. For example, the building layout visualization system 112 can be a user device carried by a designer or technician into a building and/or a portion of the processing performed by the building layout visualization system 112 can be performed by a networked/cloud-based computer system.

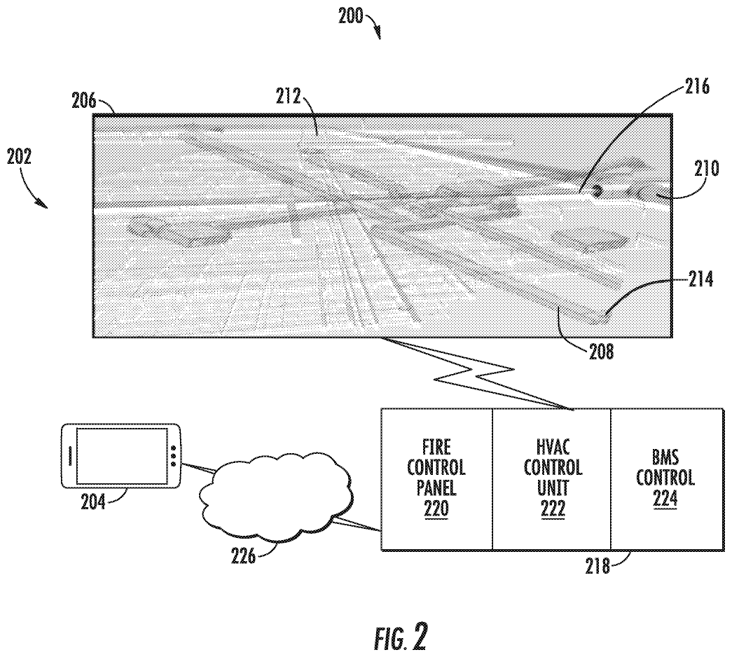

FIG. 2 depicts a system 200 at a building 202, where a user device 204 implements all or a portion of the building layout visualization system 112 of FIG. 1. The user device 204 can be a mobile device, a tablet computer, a wearable device (e.g., augmented reality glasses), a laptop computer, or other such portable computing device. The user device 204 is operable to identify the location of the user device 204, as later described herein, within the building 202 for a portion 206 of ductwork layout 208 and a fire suppression system layout 210 with respect to structure 212 of the building 202. The structure 212 can include support beams, various fixtures, support columns, walls, ceilings, floors, and the like. The ductwork layout 208 can include HVAC components 214, such as air ducts, registers, returns, sensors, air handling units, fans, and the like. The fire suppression system layout 210 can include fire suppression components 216, such as pipes, sprinklers, pumps, valves, and the like. Upon installation, the ductwork layout 208 and the fire suppression system layout 210 may be concealed behind a drop ceiling, routed through walls, or otherwise be obstructed from view by an observer in close physical proximity.

In embodiments, a building monitoring system 218 is configured to interface with the HVAC components 214 and the fire suppression components 216. For example, the building monitoring system 218 can include a fire control panel 220, an HVAC control unit 222, and building management system controls 224. The fire control panel 220 can monitor the status of the fire suppression components 216 and may trigger release of a fire extinguishing agent through the fire suppression components 216 responsive to detecting a fire condition. The fire control panel 220 may also run diagnostic tests upon the fire suppression components 216 to identify servicing needs. The HVAC control unit 222 can control heating/cooling airflow through the HVAC components 214 and may detect various fault conditions or servicing needs, such as filter replacement, reduced/blocked airflow, leakage, cleaning, and the like. The building management system 224 can capture diagnostic data and location data from the fire control panel 220 and the HVAC control unit 222, and provide the data to the user device 204, for instance, through a network 226.

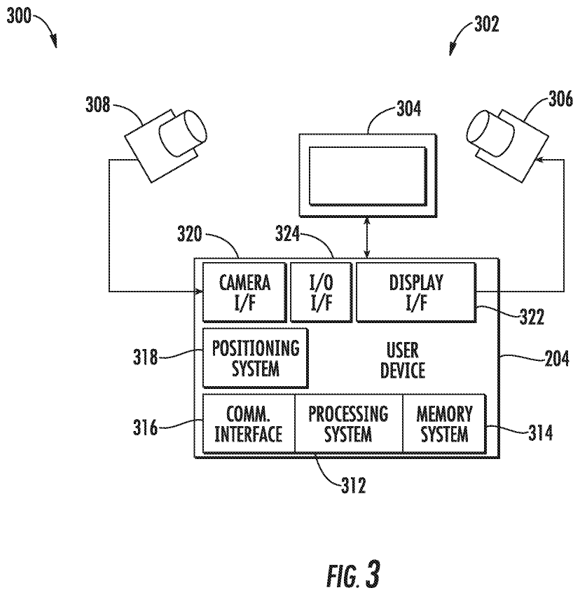

FIG. 3 is an example of a system 300 (e.g., all or a portion of building layout visualization system 112 of FIG. 1) that includes the user device 204 of FIG. 2 operably coupled to or integrated with at least one display component 302. The at least one display component 302 can include a display screen 304, such as a touch screen or other such display, and/or a holographic projector 306. The holographic projector 306 is operable to project a three-dimensional image based on one or more data sources, such as the building structural data 106, ductwork layout data 108, and fire suppression system layout data 110 of FIG. 1. The system 300 can also include a camera 308 operably coupled to or integrated with user device 204. The camera 308 can be a video/image capturing device.

The user device 204 can include processing system 312 operably coupled to a memory system 314. The processing system 312 can include any number or type of processor(s) operable to execute instructions. For example, the processing system 312 may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory system 314 may be a storage device such as, for example, a random access memory (RAM), read only memory (ROM), or other electronic, optical, magnetic or any other computer readable storage medium. The memory system 314 is an example of a tangible storage medium readable by the processing system 312, where software is stored as executable instructions for execution by the processing system 312 to cause the system 300 to operate as described herein.

The user device 204 can also include a communication interface 316 to establish and maintain wireless connectivity over network 226 of FIG. 2 (e.g., Internet, cellular, Wi-Fi, Bluetooth, Z-Wave, ZigBee, etc.) with one or more other systems, such as the building monitoring system 218 and/or to access various files and/or databases (e.g., building structural data 106, ductwork layout data 108, and fire suppression system layout data 110 of FIG. 1).

The user device 204 can also include or interface with a positioning system 318. The positioning system 318 can be configured to determine a location (i.e., current position) of the user device 204. The location can include (x, y, z) coordinates of the user device 204 in relation to the building 202 of FIG. 2. For example, the (x, y, z) coordinates may translate to a latitude, a longitude, and an elevation. The positioning system 318 may use various methods in order to determine the location of the user, such as, for example, global positioning system (GPS), Bluetooth triangulation, Wi-Fi triangulation, cellular signal triangulation, or any other location determination method known to one of skill in the art.

The user device 204 can further include various support interfaces, such as a camera interface 320 for interfacing with the camera 308, a display interface 322 for interfacing with the at least one display component 302, and an input/output interface 324 to support other inputs and outputs. For example, the inputs and outputs supported by the input/output interface 324 can include various buttons, audio inputs, audio outputs, orientation sensors, haptic feedback actuators, and the like.

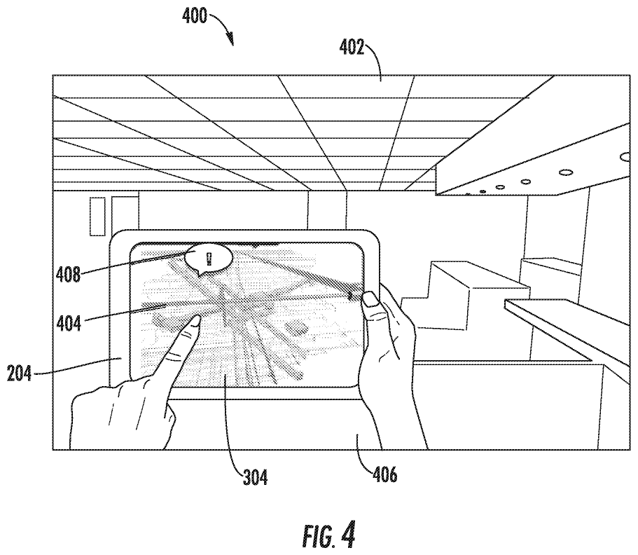

Turning now to FIG. 4 with continued reference to FIGS. 1-3, the user device 204 is depicted in a finished building environment 400, where the ductwork layout 208 and fire suppression system layout 210 of FIG. 2 are concealed behind a drop ceiling 402. The display screen 304 of the user device 204 displays an overlay image 404 including a three-dimensional depiction of a portion 206 of a ductwork layout 208 and a fire suppression system layout 210 of FIG. 2 based on an overlay of the ductwork layout data 108 and the fire suppression system layout data 110 with respect to the building structural data 106 of FIG. 1 and a location 406 of the user device 204. For instance, the positioning system 318 of FIG. 3 can determine the location 406 and the location 406 can be mapped to physical layout constraints of the ductwork layout 208 and fire suppression system layout 210 as installed in the building 202 of FIG. 2. In some embodiments, the camera 308 of FIG. 3 can be used to capture image data at the location 406 to assist in identifying where to visually overlay features and/or to provide context/background images for augmented reality display. For instance, the camera 308 can capture an image at the location 406 and the overlay image 404 can be superimposed on the image to illustrate where the ductwork layout 208 and fire suppression system layout 210 of FIG. 2 are concealed behind the drop ceiling 402.

Further, when a notification is received to locate a targeted component, the overlay image 404 can be modified with an indicator 408 to highlight where the targeted component is positioned relative to the location 406. Location and identification of a targeted component can be received, for example, from the building monitoring system 218, to assist in servicing of the building 202.

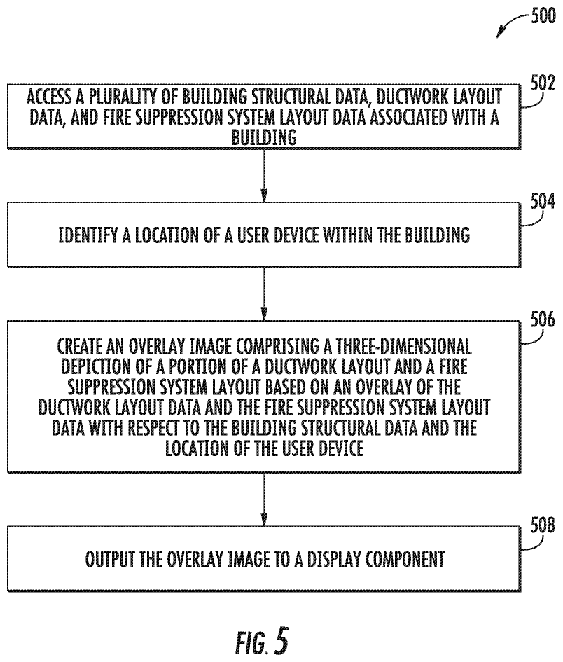

Turning now to FIG. 5, a process flow 500 that can be executed by the building layout visualization system 112 of FIG. 1 is depicted. The process flow 500 is described in reference to FIGS. 1-5 and may include additional steps beyond those depicted in FIG. 5.

At block 502, the system building layout visualization system 112 can access a plurality of building structural data 106, ductwork layout data 108, and fire suppression system layout data 110 associated with a building 202. At block 504, the building layout visualization system 112 can identify a location 406 of a user device 204 within the building 202. The user device 204 can be part or all of the building layout visualization system 112.

At block 506, the building layout visualization system 112 can create an overlay image 404 comprising a three-dimensional depiction of a portion 206 of a ductwork layout 208 and a fire suppression system layout 210 based on an overlay of the ductwork layout data 108 and the fire suppression system layout data 110 with respect to the building structural data 106 and the location 406.

At block 508, the building layout visualization system 112 can output the overlay image 404 to a display component 302. The building layout visualization system 112 can access a plurality of image data received from a camera 308 at the location 406 and generate an augmented reality view based on a combination of the image data and the overlay image 404. The augmented reality view can be output to the display screen 304. Alternatively, the overlay image 404 can be output as a holographic projection by the holographic projector 306.

In some embodiments, the building layout visualization system 112 can identify a routing conflict between the ductwork layout 208 and the fire suppression system layout 210 and output a notification of the routing conflict. The notification can be a visual indicator the overlay image 404 or a message that may be sent to another system via the communication interface 316. The building layout visualization system 112 may also receive a diagnostic notification from a building monitoring system 218, map the diagnostic notification to a service location in the building 202, and output an indicator 408 with the overlay image 404 to highlight the diagnostic notification at the service location. The building layout visualization system 112 can scale the ductwork layout 208 and the fire suppression system layout 210 in the overlay image 404 to match a plurality of actual dimensions of the ductwork layout 208 and the fire suppression system layout 210. The overlay image 404 can be scaled to project onto an installation surface of the ductwork layout 208 and the fire suppression system layout 210, for instance, prior to installation or after installation to confirm positioning. Further, the overlay image 404 can be scaled to project onto a surface covering the ductwork layout 208 and the fire suppression system layout 210, such as a ceiling, wall, or floor preventing a direct view of the ductwork layout 208 and/or the fire suppression system layout 210.

Embodiments herein can include a system, a method, and/or a computer program product at any possible technical detail level of integration. The computer program product may include a computer readable storage medium (or media) having computer readable program instructions thereon for causing a processor to carry out aspects of the embodiments herein.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the embodiments herein may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays, or programmable logic arrays may execute the computer readable program instructions by utilizing state information of the computer readable program instructions to personalize the electronic circuitry, to perform aspects of the embodiments herein.

Aspects of the embodiments herein are described herein with reference to flowchart illustrations and/or block diagrams of methods, apparatus (systems), and computer program products according to embodiments herein. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Aspects of the embodiments are described herein with reference to flowchart illustrations, schematics, and/or block diagrams of methods, apparatus, and/or systems according to embodiments. Further, the descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A system comprising:
a memory system storing a plurality of executable instructions; and
a processing system operably coupled to the memory system, wherein the executable instructions when executed by the processing system cause the system to:
access a plurality of building structural data, ductwork layout data, and fire suppression system layout data associated with a building;
identify a location of a user device within the building;
create an overlay image comprising a three-dimensional depiction of a portion of a ductwork layout and a fire suppression system layout based on an overlay of the ductwork layout data and the fire suppression system layout data with respect to the building structural data and the location of the user device; and
output the overlay image to a display component.

2. The system of claim 1, wherein the display component comprises a display screen.

3. The system of claim 2, wherein the executable instructions when executed by the processing system cause the system to:
access a plurality of image data received from a camera at the location;
generate an augmented reality view based on a combination of the image data and the overlay image; and
output the augmented reality view to the display screen.

4. The system of claim 1, wherein the display component comprises a holographic projector, and the overlay image is output as a holographic projection by the holographic projector.

5. The system of claim 1, wherein the executable instructions when executed by the processing system cause the system to:
identify a routing conflict between the ductwork layout and the fire suppression system layout; and
output a notification of the routing conflict.

6. The system of claim 1, wherein the executable instructions when executed by the processing system cause the system to:
receive a diagnostic notification from a building monitoring system;
map the diagnostic notification to a service location in the building; and
output an indicator with the overlay image to highlight the diagnostic notification at the service location.

7. The system of claim 1, wherein the executable instructions when executed by the processing system cause the system to:
scale the ductwork layout and the fire suppression system layout in the overlay image to match a plurality of actual dimensions of the ductwork layout and the fire suppression system layout.

8. The system of claim 7, wherein the overlay image is scaled to project onto an installation surface of the ductwork layout and the fire suppression system layout.

9. The system of claim 7, wherein the overlay image is scaled to project onto a surface covering the ductwork layout and the fire suppression system layout.

10. The system of claim 1, wherein the executable instructions when executed by the processing system cause the system to:
adjust the overlay image as the user device is moved to a different location and/or orientation.

11. A method comprising:
accessing a plurality of building structural data, ductwork layout data, and fire suppression system layout data associated with a building;
identifying a location of a user device within the building;
creating an overlay image comprising a three-dimensional depiction of a portion of a ductwork layout and a fire suppression system layout based on an overlay of the ductwork layout data and the fire suppression system layout data with respect to the building structural data and the location of the user device; and
outputting the overlay image to a display component.

12. The method of claim 11, wherein the display component comprises a display screen.

13. The method of claim 12, further comprising:
accessing a plurality of image data received from a camera at the location;
generating an augmented reality view based on a combination of the image data and the overlay image; and
outputting the augmented reality view to the display screen.

14. The method of claim 11, wherein the display component comprises a holographic projector, and the overlay image is output as a holographic projection by the holographic projector.

15. The method of claim 11, further comprising:
identifying a routing conflict between the ductwork layout and the fire suppression system layout; and
outputting a notification of the routing conflict.

16. The method of claim 11, further comprising:
receiving a diagnostic notification from a building monitoring system;
mapping the diagnostic notification to a service location in the building; and
outputting an indicator with the overlay image to highlight the diagnostic notification at the service location.

17. The method of claim 11, further comprising:
scaling the ductwork layout and the fire suppression system layout in the overlay image to match a plurality of actual dimensions of the ductwork layout and the fire suppression system layout.

18. The method of claim 17, wherein the overlay image is scaled to project onto an installation surface of the ductwork layout and the fire suppression system layout.

19. The method of claim 17, wherein the overlay image is scaled to project onto a surface covering the ductwork layout and the fire suppression system layout.

20. The method of claim 11, further comprising:
adjusting the overlay image as the user device is moved to a different location and/or orientation.
